(19) United States
(12) Patent Application Publication
(10) Pub. No.: US 2006/0144877 A1
(43) Pub. Date: Jul. 6, 2006

(54) Method and apparatus for preventing the undesirable curing of materials contained within opened cartridges or tubes

(76) Inventors: Lee Greenberg, Greenbrae, CA (US); Manuel L. Karell, San Francisco, CA (US)

Correspondence Address: LEE GREENBERG, 14 LUCKY DRIVE, GREENBRAE, CA, 94904, US

(21) Appl. No.: 11/030,267

(22) Filed: Jan. 5, 2005

(51) Int. Cl. B65D 47/00; B67D 3/00

(52) U.S. Cl. 222/562

(57) ABSTRACT

A method and apparatus of preventing the curing of an air curable material within an opened cartridge or tube by using a liquid within a container and introducing the spout into the liquid.

### BACKGROUND OF THE INVENTION

1. Technical Field

Adhesives and sealants such as caulking and other air curable materials are typically provided in a cartridge or squeezable tube. This invention relates to solving the problem of preventing air from curing the materials in a partially used cartridge or tube by using a liquid as a seal.

A conventional cartridge or tube generally has a tubular body with a forward moving expulsion/sealing disk at the rear end and an elongated dispensing spout protruding outwardly from the front end. A squeezable tube also has a tubular body member with a squeezable or foldable rear end and a dispensing spout in oppositely disposed front end. For use, the dispensing spout is cut open, unsealing the cartridge or tube. Often there is an additional inner seal which requires piercing with a nail or rod. When the contents of the cartridge or tube are not entirely dispensed, preventing exposure to the atmosphere is needed to prevent curing of the remaining material. Many times, the cartridge is retained in a caulking gun.

2. Description of Prior Art

In use, most users of adhesives and sealants such as caulking compounds or other air curable materials, usually insert a nail or screw into the spout, or wrapped the spout with plastic film or tape in an effort to prevent the atmosphere from curing the remaining material.

Prior art patents have disclosed a number of other sealing devices, see for example U.S. Pat. Nos. 3,486,503, 3,930,599, 4,284,213, 5,104,013, 5,301,843 and 6,824,026.

In U.S. Pat. No. 3,486,503 a screw based cap having an insert is used.

U.S. Pat. No. 3,930,599 discloses a cap for caulking cartridge wherein a cap is engaged over the entire end of the tube.

U.S. Pat. No. 4,284,213 claims a cap that can be inverted and introduced into the spout.

U.S. Pat. No. 5,104,013 claims a series of engageable cap elements.

U.S. Pat. No. 5,301,843 discloses a combination caulking tube cap and application device.

Finally, U.S. Pat. No. 6,824,026 discloses an elongated cap resiliently conforming to the surface of the nozzle thus making an elongated annular seal.

### SUMMARY OF THE INVENTION

A liquid is utilized to reseal the opening of the cartridge or tube thereby providing a true air excluding environment. Using a liquid as a seal solves the problem by preventing the atmosphere from curing caulk and other air curing materials. Excluding the atmosphere from the spout of a cartridge or tube is accomplished by immersing the spout into a liquid filled portable vessel that remains affixed to the spout until further use of the cartridge. This portable vessel can be utilized when the cartridge is retained within the caulking gun. The method and apparatus are effective regardless of the spout angle.

The instant invention provides for a method of using a liquid as a seal. This method includes a portable vessel containing a liquid and into which the spout of an opened cartridge or tube is inserted, thus providing a seal, thereby preventing curing of the material contained within the cartridge or tube. The method concept allows for the vessel to be portable and affixable to the spout, even if retained in a caulking gun.

The instant invention provides for an apparatus utilizing a liquid as a seal. The apparatus is portable and affixable to the spout, even if retained in a caulking gun.

Further, the instant invention provides for a method and apparatus of converting a pliable body such a ball into a portable vessel containing a liquid and into which the spout of an opened cartridge or tube is inserted, thus providing a seal, thereby preventing curing of the material contained within the cartridge or tube.

The basic embodiment of the instant invention is a rubber body, such as a ball, having a small hole through which a liquid, e.g. water, is introduced; the spout of the caulking cartridge or tube is then introduced through the hole such that the liquid makes an air excluding environment to the spout. The elasticity of the rubber affixing to the spout provides for a liquid retaining means. The liquid retaining means may be a separate apparatus introduced into and through the pliable exterior wall of the body wherein this liquid retaining means may also have a spout accepting means. The rubber body is a vessel to contain the liquid; obviously, the vessel can be made of other pliable materials and the shape of the vessel could be elongated to follow the general shape of the spout. The liquid or semi-liquid or gel may be water-based or petroleum-based or other substance, compound or mixture which is known in the art to prevent curing of material.

Another variation to the instant invention is a thick balloon in which the mouthpiece is turned inward into the body of the balloon producing an inward facing duck-billed valve. A liquid is introduced into the balloon through the inverted mouthpiece; spillage is prevented by the valve function of the inverted mouth piece. The spout is wiped off and introduced into and through the rear of the duck-billed valve. The inverted mouth piece stretches to conform to the spout. The spout of the cartridge or tube introduced becomes encompassed by the liquid.

Another variation to the instant invention is to provide a means for converting the ubiquitous rubber or other pliable material ball into the basic invention for a liquid to provide an air excluding environment. This is accomplished with a hollow structural assembly having a piercing means, with which the wall of a rubber ball is pierced. This piercing means, may or may not be unitary with a means for fastening the assembly to the ball's wall, a means for inserting the liquid into the ball, a means for retaining the liquid, a means for preventing liquid spillage, and a means for introducing the spout into cavity of the ball.

### DESCRIPTION OF THE DRAWINGS

FIG. 1 is view of a partial cross-sectional view of the instant invention wherein a rubber ball having a hole is filled with a liquid to provide an air excluding environment of a spout of a dispensing cartridge or tube.

FIG. 2 is a view of a balloon shaped apparatus in which the mouthpiece in inverted forming a duck-billed valve.

FIG. 2A is a view of a spout inserted through the rear of the duck-billed valve and into liquid.

FIG. 3 is a view of a piercing means for converting a rubber ball into the instant invention.

FIG. 3A and FIG. 3B are views of a piercing means positioned within a ball, a liquid introduced into cavity of the ball, and a spout introduced into the liquid.

FIG. 4 is a view of a piercing means shaped as a hollow screw.

FIG. 5 is a view of a piercing means in which the fastening means is toggle-bolt like.

FIG. 6 is a view of a fastening means having at flexible, laterally extendable wing member unitary with and on the exterior of the structural assembly.

### DESCRIPTION OF THE PREFERRED EMBODIMENT

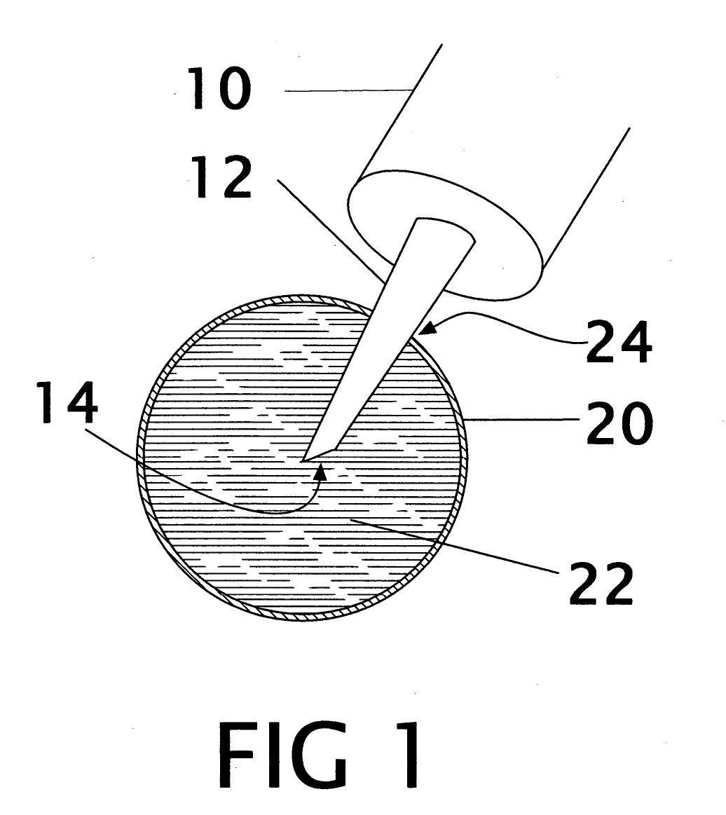

Referring to FIG. 1 of the drawings, an air curable material cartridge or tube 10 can be seen having a spout 12 in which a portion of the tip 14 has been cut away for use as will be well understood by those skilled in the art. The instant invention as seen in FIG. 1 wherein a rubber ball 20 having a liquid 22 contained within is utilized to provide an air excluding environment to spout 12 thereby protecting contents (not shown) within spout 12 and cartridge 20. The cartridge or tube spout 12 is introduced through rubber ball hole 24, which provides sufficient elasticity to surround and retain spout 12 and prevent spillage of the liquid 22.

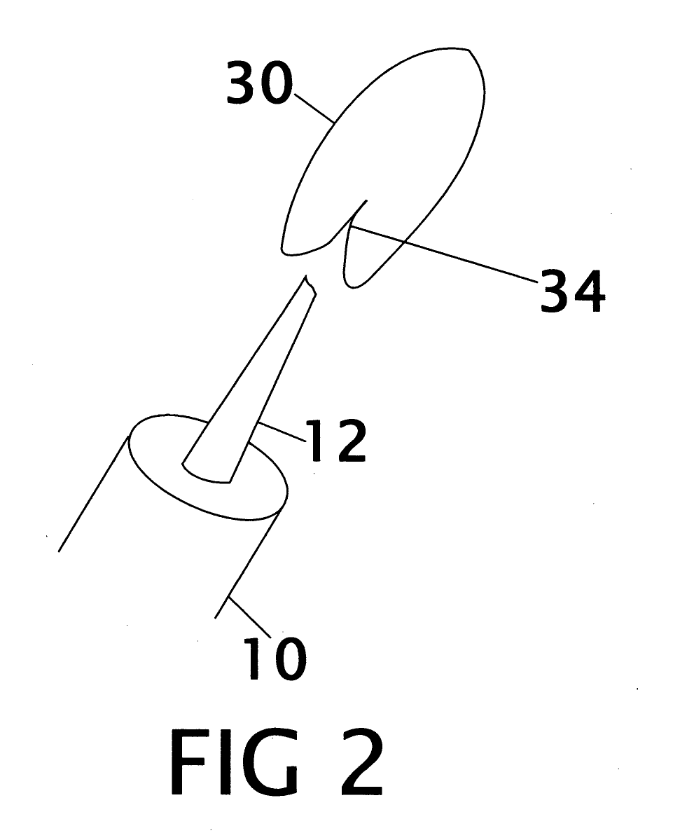

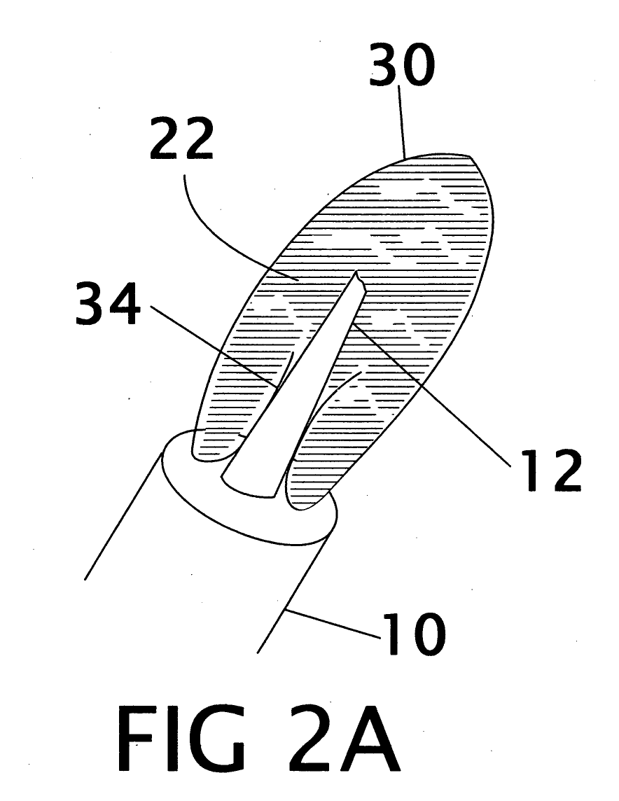

A variation of the instant invention is seen in FIG. 2 as a balloon 30 with an inverted mouthpiece 34. As is seen in FIG. 2A a liquid 22 is within balloon 30 making an air excluding environment with spout 12. In operation, a liquid is introduced through mouthpiece 34 and thereafter spout 12 is introduced through mouthpiece 34 which provides sufficient elasticity to surround and retain spout 12 and prevent spillage of the liquid 22. The inverted mouthpiece 34 acts as a duck-billed valve thereby preventing liquid spillage when no spout is present. Whereas, FIG. 2 and FIG. 2A show for clarity a single duck-billed valve, a valve consisting of multiple duck-billed formations in series may be used.

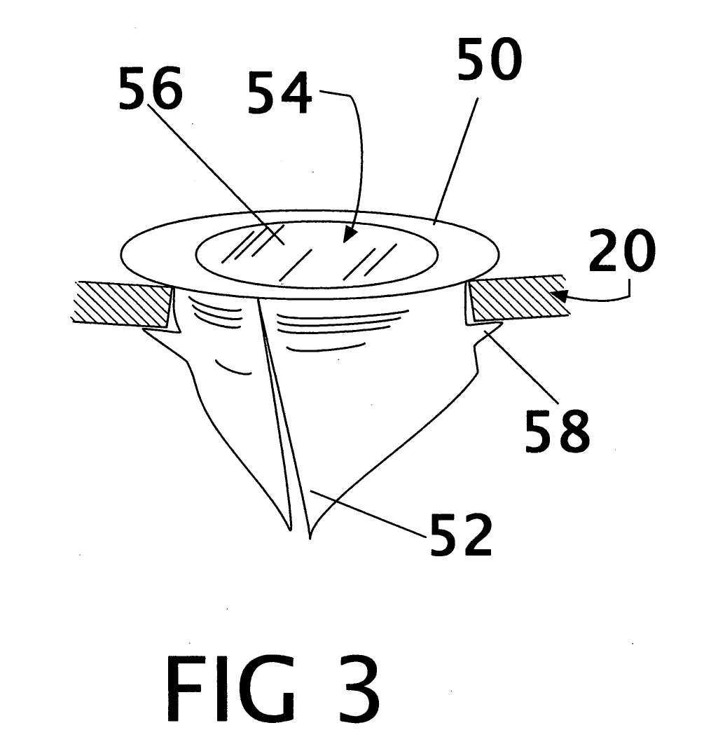

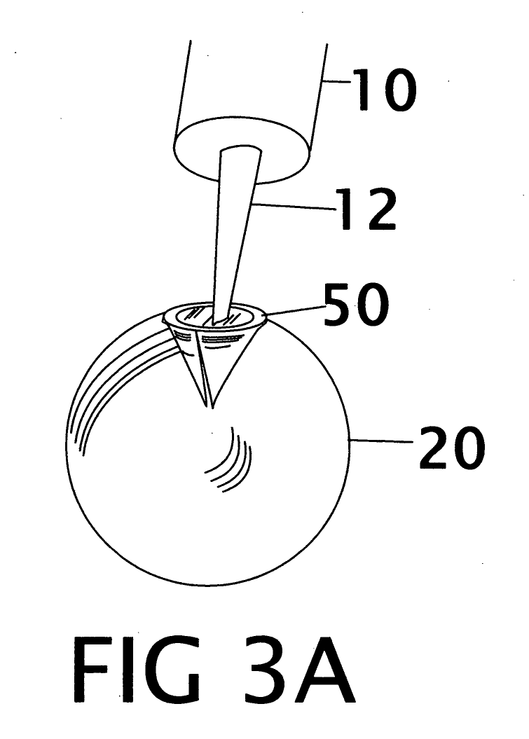

Referring to FIG. 3 a hollow structural assembly means 50 comprises a piercing means 52 on one end and a spout accepting means 54 on the other end; interposed on the outer surface of assembly 50 is fastening means 58 shown fastening assembly to wall of a ball 20; liquid retaining means 56 may be a membrane-like covering the spout accepting means 54. In operation, the assembly means 50 is pushed through wall 20 such that fastening means 58 fastens assembly to wall. Once assembly 50 is positioned, a liquid is introduced into the cavity within ball. As is shown in FIGS. 3A and 3B the spout 12 of opened cartridge or tube I 0 is inserted such that the spout becomes surrounded by the liquid 22 thereby preventing air for reaching the spout thereby preventing curing. Liquid retaining means 56 (as is seen in FIG. 3) is stretched surrounding spout 12 thereby preventing liquid spillage.

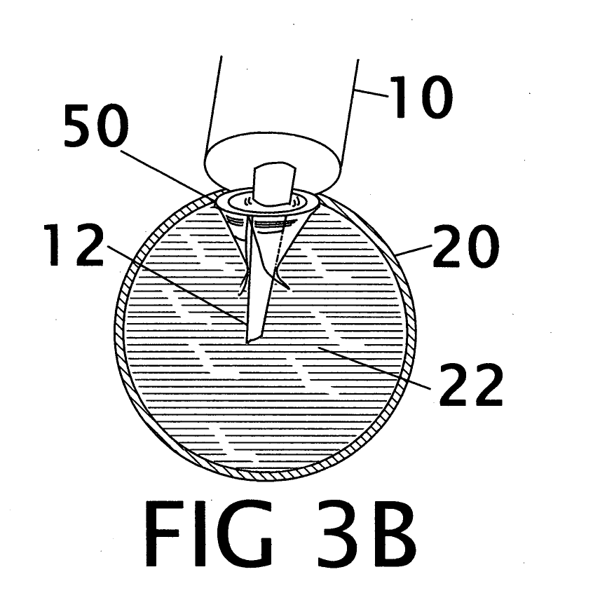

As is seen in FIG. 4 a hollow structural assembly means 50 comprising a screw-like 59 means may be used for screwing the assembly into position.

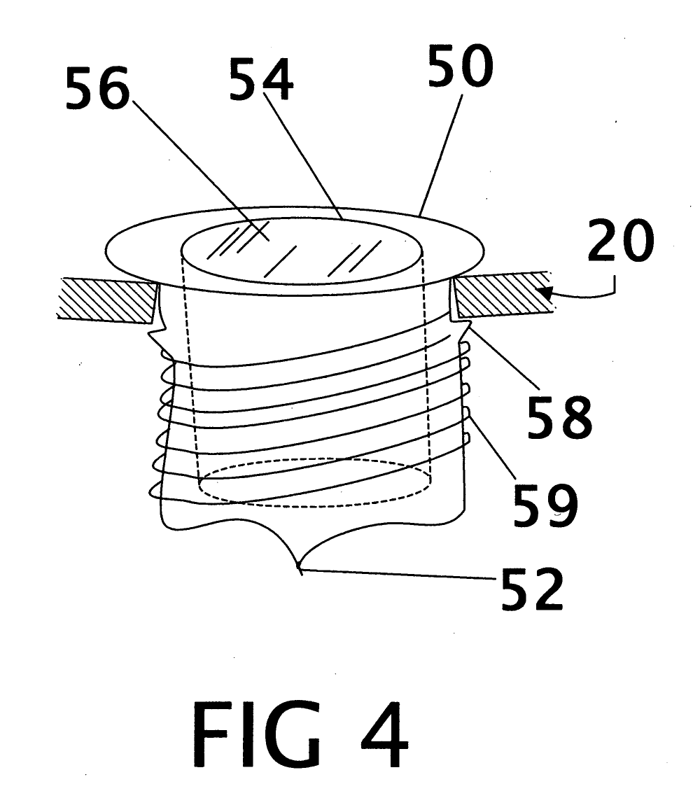

As is seen in FIG. 5 a hollow structural assembly means 50 comprising a toggle-bolt like 62 means may be used for placing and fastening the assembly into position.

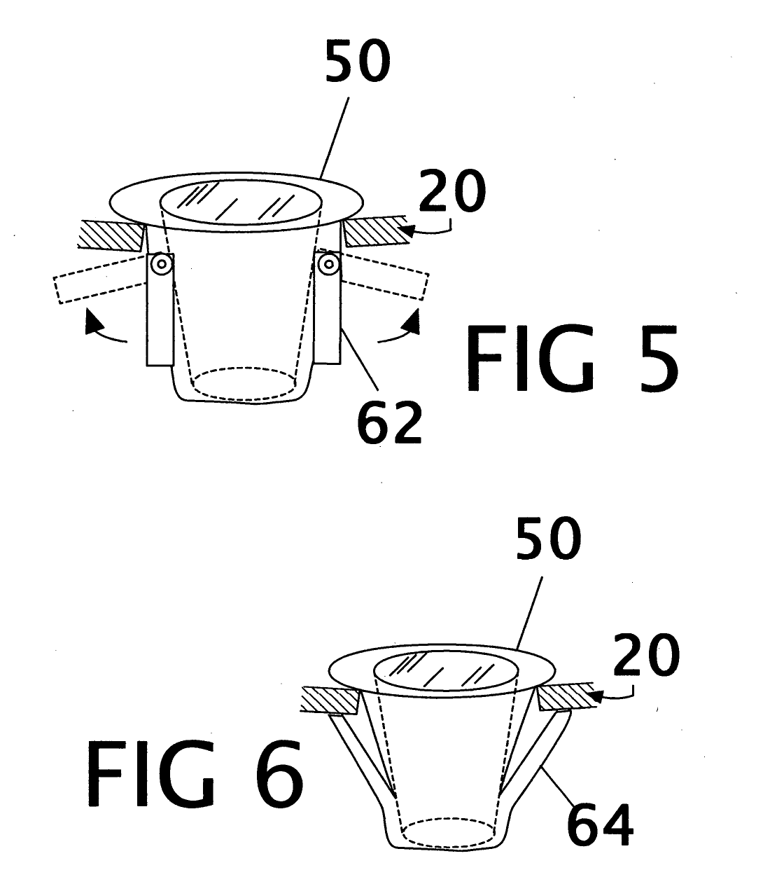

As is seen in FIG. 6 a hollow structural assembly means 50 comprising at least one flexible, laterally extendable wing member 64 unitary with and on the exterior of the structural assembly may be utilized for placing and fastening the assembly into position.

It will thus be seen that a new and novel means for excluding the atmosphere from an opened cartridge or tube has been illustrated and described and it will be apparent to those skilled in the art that various changes and modifications may be made therein without departing from the spirit of the invention.

What is claimed is:

1. A method of preventing the curing of an air curable material within an opened cartridge or tube comprising the steps of:
providing a container being capable of accepting a spout from an opened cartridge or tube;
placing a liquid within said container;
introducing the spout from the cartridge or tube into the liquid within said container thereby providing to the spout an air excluding environment thereby preventing curing.

2. A method of preventing the curing of an air curable material within an opened cartridge or tube comprising the steps of:
providing a portable container having an opening wherein said opening is capable of accepting and affixing a spout from an opened cartridge or tube and wherein said opening is elastic for stretching and surrounding the spout for retaining a liquid without spillage;
introducing a liquid into said container for providing a liquid seal to the spout;
introducing the spout from the cartridge or tube into the liquid within said container thereby providing to the spout an air excluding environment thereby preventing curing of an air curable material within an opened cartridge or tube.

3. A method of converting a pliable body having a cavity into a means of preventing the curing of an air curable material within an opened cartridge or tube consisting of:
manufacturing a hollow piercing means for piercing the wall of a pliable body, said piercing means containing a fastening means for fastening to the wall of the pliable body, a liquid retaining means for preventing liquid spillage, and a spout accepting means for receiving a spout of a cartridge or tube;
piercing the wall of a pliable body with said hollow piercing means;
fastening the piercing means to the wall;
introducing a liquid into the cavity of the pliable body via the hollow piercing means;
introducing the spout into the liquid via the hollow piercing means, thereby providing to the spout an air excluding environment, thereby preventing curing.

4. An apparatus utilizing method of claim 2 for traversing with and preventing the curing of an air curable material within an opened spout of a cartridge or tube consisting of:
a portable container for holding a liquid within;
said container having an opening for introducing said liquid;
said container additionally having a liquid retaining means for retaining said liquid within;
said container additionally having a spout accepting means for accepting the spout of a cartridge or tube wherein an opened spout is introduced into the container for said liquid to provide an air excluding environment thereby preventing curing.

5. An apparatus of claim 4 wherein said container is pliable.

6. An apparatus of claim 4 wherein said liquid retaining means is composed of elastic stretchable material capable of forming a seal around an inserted spout to prevent the spillage of liquid and additionally capable of repeated insertions.

7. An apparatus of claim 4 wherein said liquid retaining means and said spout accepting means are unity.

8. An apparatus of claim 4 wherein said liquid retaining means, said spout accepting means, and said container opening are unity.

9. An apparatus of claim 4 wherein said container is a rubber ball.

10. An apparatus of claim 8 wherein said rubber ball contains an opening in its wall wherein said opening provides for said liquid retaining means and for said spout accepting means.

11. An apparatus utilizing method claim 2 for preventing the curing of an air curable material within an opened cartridge or tube comprising:
a pliable hollow ball wherein the wall of the ball has an opening means wherein said opening means is utilized for introducing a liquid, for accepting and affixing a spout from an opened cartridge or tube, for stretching and surrounding the spout for retaining a liquid without spillage thereby providing to the spout an air excluding environment thereby preventing curing of an air curable material within an opened cartridge or tube.

12. An apparatus of claim 4 wherein said container is a thick balloon in which the mouthpiece is inverted into the cavity of the balloon and wherein said liquid retaining means and said spout accepting means are said inverted mouthpiece.

13. An apparatus of claim 2 wherein said liquid is water-based or oil-based or other substance, compound or mixture which can prevent curing of material.

14. An apparatus of claim 3 for converting a hollow ball into a means of preventing the curing of an air curable material within an opened cartridge or tube consisting of:
A firm hollow structural assembly for inserting through the wall of a ball wherein said assembly comprises a piercing means at one end for piercing the wall of the ball, and a spout accepting means at the opposite end for accepting the spout of a cartridge for introducing said spout into the cavity of said ball;
additionally said assembly comprising a fastening means interposed between the ends for fastening said structural assembly to said wall;
additionally said assembly comprises a liquid retaining means positioned within or over said spout accepting means for retaining an introduced liquid within said ball, wherein said introduced spout becomes surrounded by said introduced liquid thereby providing to the spout an air excluding environment thereby preventing curing.

15. An apparatus of claim 13 wherein said assembly comprising a piercing means, a spout accepting means, a fastening means, a liquid retaining means are unity.

16. An apparatus of claim 13 wherein said fastening means is a protrusion from said hollow structural assembly.

17. An apparatus of claim 13 wherein said hollow structural assembly is in the shape of a hollow screw.

18. An apparatus of claim 13 wherein said fastening means is in the shape of a toggle-bolt.

19. An apparatus of claim 13 wherein said fastening means is at least one flexible, laterally extendable wing member unitary with and on the exterior of said structural assembly.
